(19) United States
(12) Patent Application Publication
(10) Pub. No.: US 2007/0088927 A1
(43) Pub. Date: Apr. 19, 2007

(54) Method of protecting a storage device for a windows operating system

(76) Inventors: Yu Rui, Taipei (TW); Wen Bin Chang, Taipei (TW); Xiaohua Guan, Taipei (TW)

Correspondence Address: G. LINK Co.,LTD, 3550 Bell Road., MINOOKA, IL, 60447, US

(21) Appl. No.: 11/251,750

(22) Filed: Oct. 18, 2005

(51) Int. Cl. G06F 12/14; G06F 12/00

(52) U.S. Cl. 711/163; 711/173

(57) ABSTRACT

A method of protecting a storage device for a Windows operating system. The method is divided into a write-proof method, a delete-proof method and a hidden partition method, which code the drivers of Lower Filter Device Object, Upper Filter Device Object, Partition n Lower Filter Device Object and Partition n Upper Filter Device Object and inserts the objects to the corresponding positions of Partition n Functional Device Object, the Disk Functional Device Object and the Bus Functional Device Object, thereby building a driver configuration respectively for the write-proof method, the delete-proof method and the hidden partition method. Thus, the objects can intercept and process a desired IRP when the IRP passes through the driver configuration.

### FIELD OF THE INVENTION

The invention relates to a method of defining device properties of a storage device for a Windows operating system, and especially to a method of changing original device properties of a storage device for a Windows operating system such that the storage device and its partitions have the properties of write-proof, delete-proof, and hidden partition.

### BACKGROUND OF THE INVENTION

Because all known Windows operating systems in Microsoft Corporation have disclosed the drivers of Partition n Functional Device Object, Disk Functional Device Object, Bus Functional Device Object and the like, these objects can have an appropriate operation to the storage device based on the default device properties, for example, formatting a hard disk, creating and deleting both a file and a partition, and so on. However, in some computer systems, these operations refer to destruction and have to be forbidden. Therefore, a subject of offering a computer system how to redefine or change the default device properties of a storage device is one of the important research and development issues for a supplier of the computer system.

Therefore, it is desirable by the inventors to apply a write-proof, delete-proof and hidden partition method for protecting a storage device and its internal partitions, thereby mitigating and/or obviating the aforementioned problems.

### SUMMARY OF THE INVENTION

An object of the invention is to provide a method of changing default device properties of a storage device into write-proof, delete-proof, hidden partition, thereby protecting the storage device and its partitions.

Another object of the invention is to provide a driver-based method in which the default device properties of a storage device is changed into write-proof, delete-proof and hidden partition after corresponding drivers are executed, thereby protecting the storage device and its partitions.

To achieve the objects of the invention, a write-proof method, a delete-proof method and a hidden partition method are provided to protect a storage device for a Windows operating system, which code the drivers of Lower Filter Device Object, Upper Filter Device Object, Partition n Lower Filter Device Object and Partition n Upper Filter Device Object and inserts the objects into positions corresponding to Partition n Functional Device Object, Disk Functional Device Object and Bus Functional Device Object to thus build a driver configuration respectively for the write-proof method, the delete-proof method and the hidden partition method. Thus, when an I/O Request Packet (IRP) passes through the driver configuration, the corresponding objects can intercept and process the IRP.

### BRIEF DESCRIPTION OF THE DRAWINGS

FIGS. 1A to 1D show embodied flowcharts of a write-proof method capable of protecting a storage device for a Windows operating system according to the invention;

FIGS. 2A to 2D show driver configurations of implementing a write-proof method according to the invention;

FIG. 2E shows a diagram of a driver hierarchy of implementing a write-proof method according to the invention;

FIG. 3 shows a write rejection frame in which a partition of a storage device is changed into a write-proof partition according to the invention;

FIG. 4 shows a flowchart of a delete-proof method capable of protecting a storage device for a Windows operating system according to the invention;

FIG. 5 shows a driver configuration of implementing a delete-proof method according to the invention;

FIG. 6 shows a delete rejection frame in which a partition of a storage device is changed into a delete-proof partition according to the invention;

FIG. 7 shows a flowchart of a hidden partition method for a Windows operating system to protect a storage device according to the invention;

FIG. 8 shows a driver configuration of implementing hidden partition method of the invention;

FIG. 9 shows a query success frame in which partitions of a storage device is not changed into hidden partitions according to the invention; and

FIG. 10 shows a frame in which a partition of FIG. 9 is changed into a hidden partition and successfully hidden according to the invention.

### DETAILED DESCRIPTION OF THE INVENTION

The invention discloses a method of protecting a storage device, which is used in a computer system with a Windows operating system to protect its storage device such as a hard disk, a fixed storage device by means of write-proof, delete-proof and hidden partition and will be described in detail as follows.

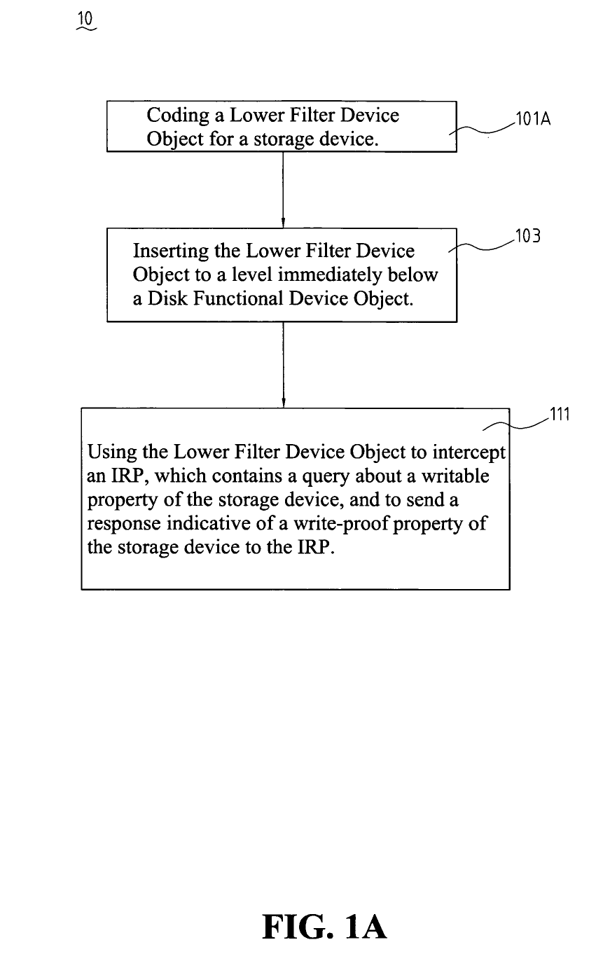

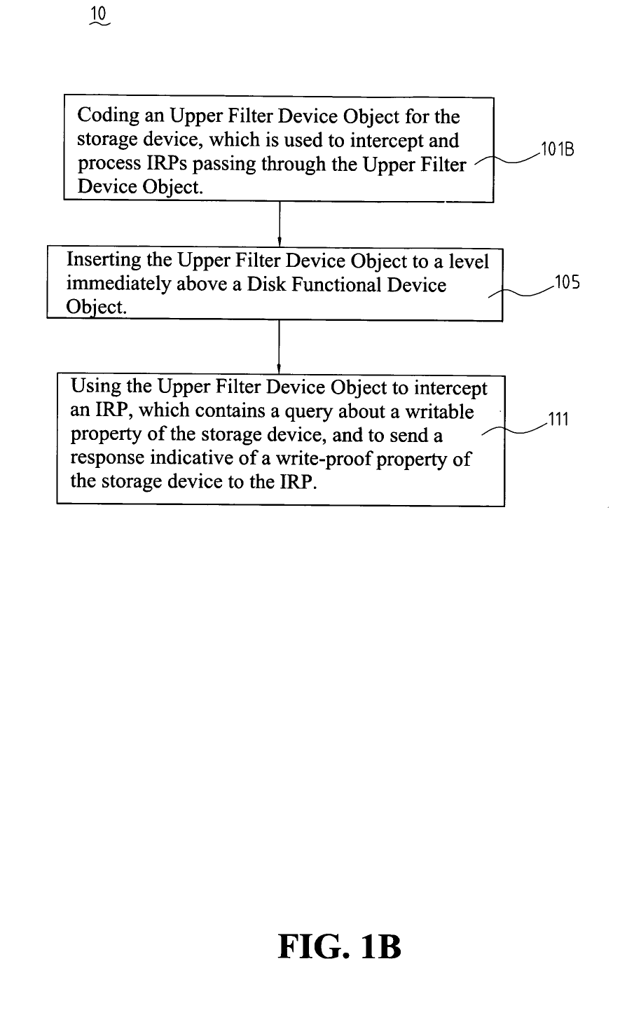

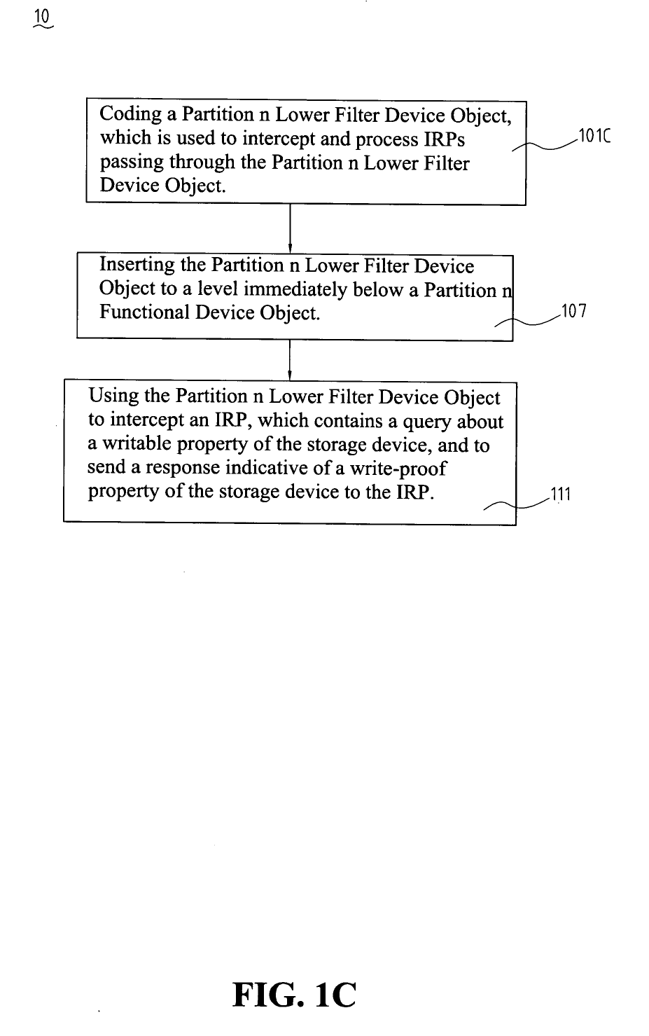

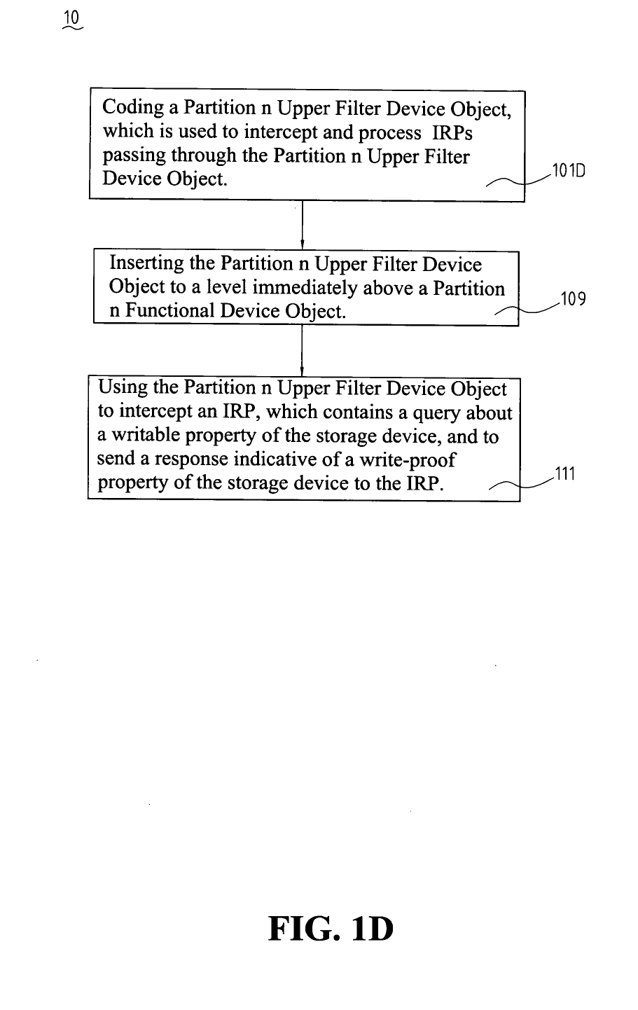

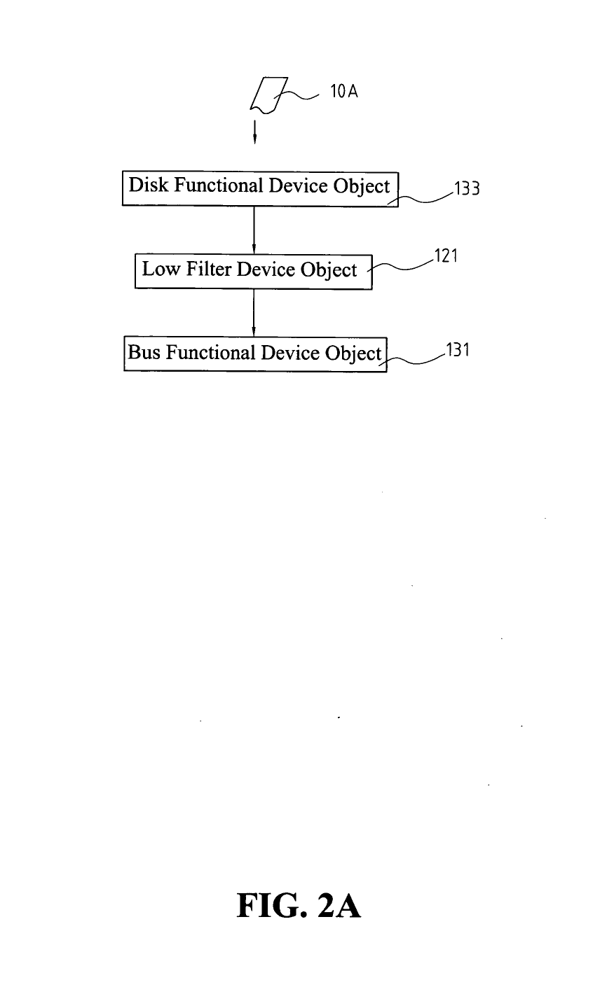

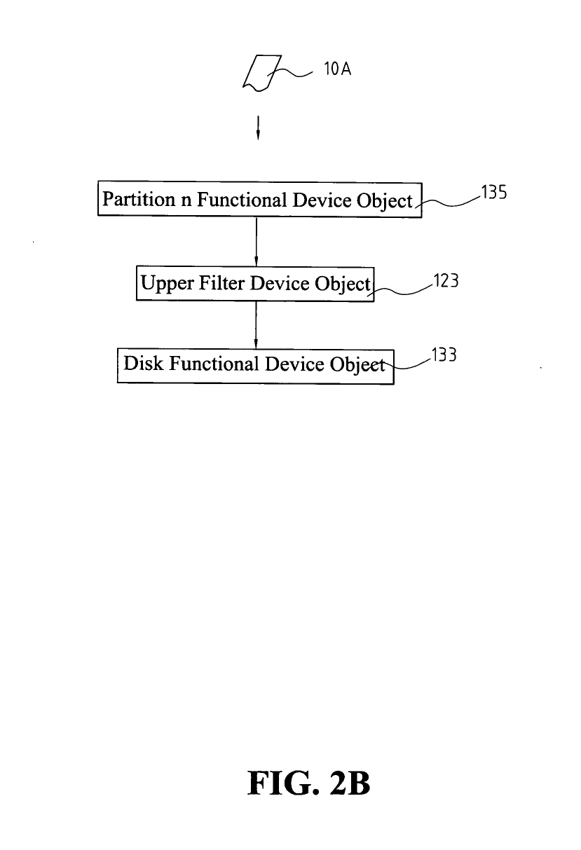

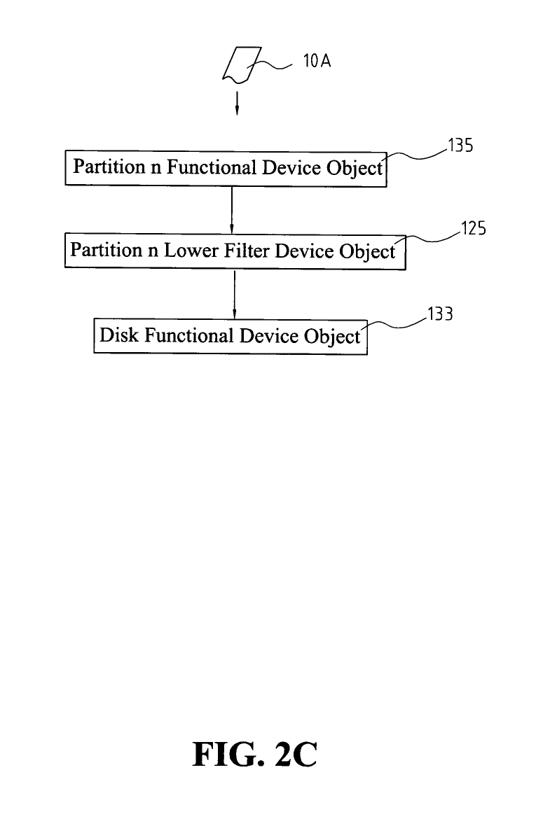

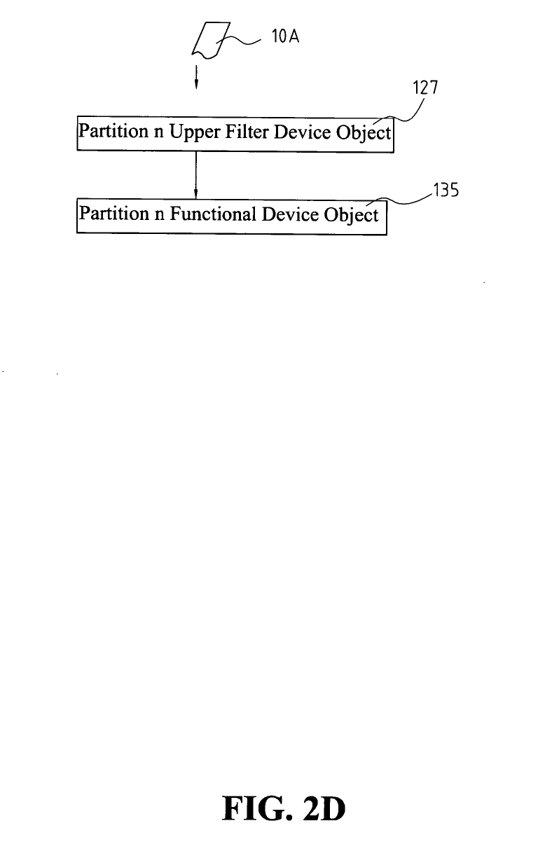

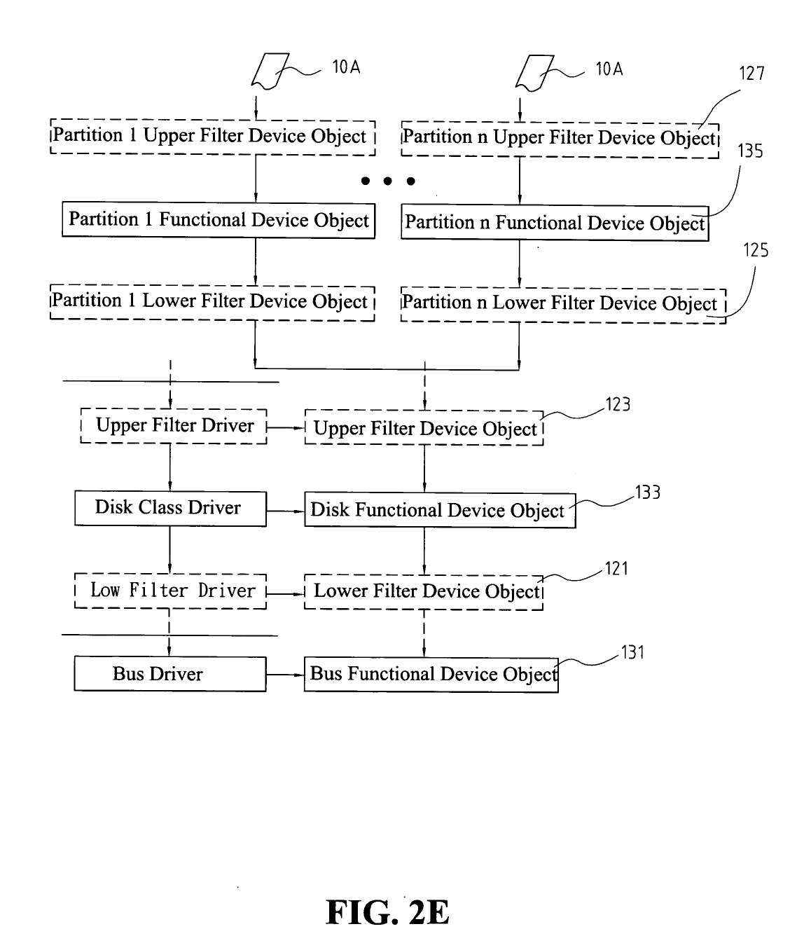

FIGS. 1A to 1D show embodied flowcharts of a write-proof method 10 capable of protecting a storage device for a Windows operating system according to the invention. FIGS. 2A to 2D show driver configurations of implementing the write-proof method 10 according to the invention. The write-proof method 10 essentially prevents the storage device from formatting the partition of storage device, creating the files, deleting the files, modifying the contents of the file, and so on. The write-proof method 10 can be implemented by four ways respectively referred to FIG. 1A to FIG. 1D and FIG. 2A to FIG. 2D. Thus, the entire storage device or a partition is changed to be unwritable.

In FIG. 1A, step 101A codes a Lower Filter Device Object 121 for a storage device. Step 103 inserts the Lower Filter Device Object 121 into the level below a Disk Functional Device Object 133. In step 111, the object 121 intercepts the IRP 10A, which contains a query about the storage device's writable property, and sends a response indicative of the storage device's write-proof property to the IRP 10A. At this point, the first embodiment of the write-proof method can be implemented, as shown in FIG. 2A.

In FIG 1B, step 101B codes an Upper Filter Device Object 123 for a storage device. Step 105 inserts the Upper Filter Device Object 123 to the level above the Disk Functional Device Object 133. In step 111, the object 123 intercepts the IRP 10A, which contains a query about the storage device's writable property, and sends a response indicative of the storage device's write-proof property to the IRP 10A. At this point, the second embodiment of the write-proof method can be implemented, as shown in FIG. 2B.

In FIG. 1C, step 101C codes a Partition n Lower Filter Device Object 125. Step 107 inserts the Partition n Lower Filter Device Object 125 to the level below a Partition n Functional Device Object 135. In step 111, the object 125 intercepts the IRP 10A, which contains a query about a storage device's writable property, and sends a response indicative of the storage device's write-proof property to the IRP 10A. The cited variable n equals to 1,2,3, . . . , or N, where variable N indicates a total partition number of the storage device. At this point, the third embodiment of the write-proof method can be implemented, as shown in FIG. 2C.

In FIG. 1D, step 101D codes a Partition n Upper Filter Device Object 127. Step 109 inserts the Partition n Upper Filter Device Object 127 to the level above the Partition n Functional Device Object 135. In step 111, the object 127 intercepts the IRP 10A, which contains a query about a storage device's writable property, and sends a response indicative of the storage device's write-proof property to the IRP 10A. The cited variable n equals to 1,2,3, . . . , or N, where variable N indicates a total partition number of the storage device. At this point, the fourth embodiment of the write-proof method can be implemented, as shown in FIG. 2D.

The objects 121, 123, 125 and 127 are a kind of drivers and can intercept and process passing IRPs (I/O Request Packets) 10A. Especially, the objects 121, 123, 125 and 127 can intercept an IRP 10A, which contains a query about a storage device's writable property, and send a response indicative of the storage device's write-proof property to the IRP 10A. Briefly, the invention codes the objects 121, 123, 125, 127, places the objects coded on positions where a storage device or partitions are required for protection, intercepts the IRP 10A, and returns a message of STATUS_MEDIA_WRITE_PROTECTED, thus the operating system regards the storage device or partition to be unwritable, thereby achieving the protection object.

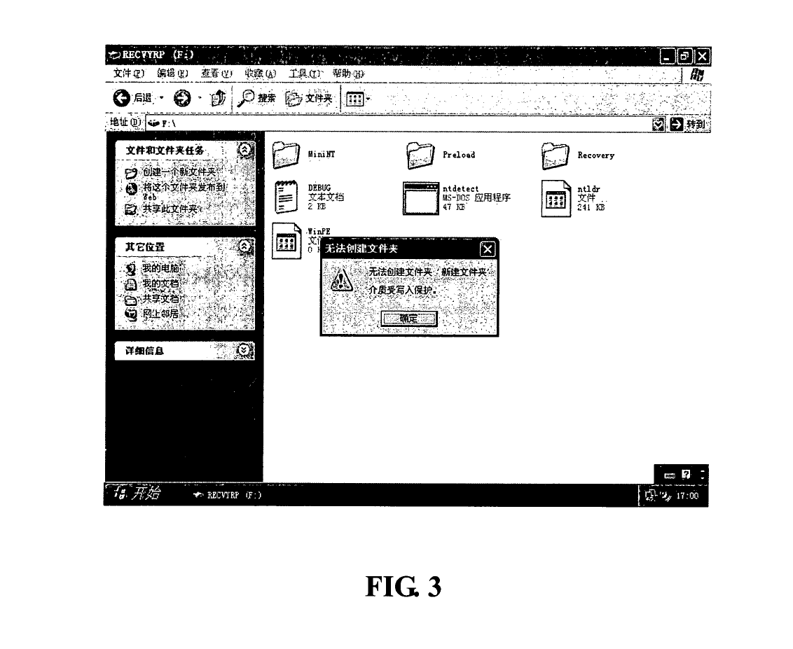

Referring to FIG. 2E, the write-proof method 10 uses a special IRP 10A, IoControlCode, as IRP_MJ_DEVICE_CONTROL of IOCTL_DISK_IS_WRITABLE. The special IRP 10A is typically used to check the properties of a storage device. In case of writable, the storage device is subsequently allowed to have a physical write operation. Accordingly, the write-proof method 10 codes a filter driver to thus protect data of the storage device from the change or even damage of a write operation. As shown in the dashed blocks of FIG. 2E, the filter driver corresponds to one of the objects 121, 123, 125, 127. One of the objects 121, 123, 125, 127 is located on a storage device or partition desired to be protected in order to intercept the special IRP 10A and send a response, such as STATUS_MEDIA_WRITE_PROTECTED, indicative of the write-proof property of the storage device to the special IRP 10A. Thus, the operating system regards the storage device or partition to be unwritable, thereby achieving the protection object. FIG. 3 shows a write rejection frame in which a partition of a storage device is changed into a write-proof partition according to the invention.

After understanding the spirit of the write-proof method 10 of the invention, those skilled in the art can choose one of the objects 121, 123, 125, 127, or the combination thereof to re-implement the driver configuration of the inventive write-proof method without departing from the scope of the invention. Further, with a practical adjustment, a filter driver can be implemented in the Upper level or Lower level of a storage device or partition. Furthermore, the filter driver can be further implemented to start in booting.

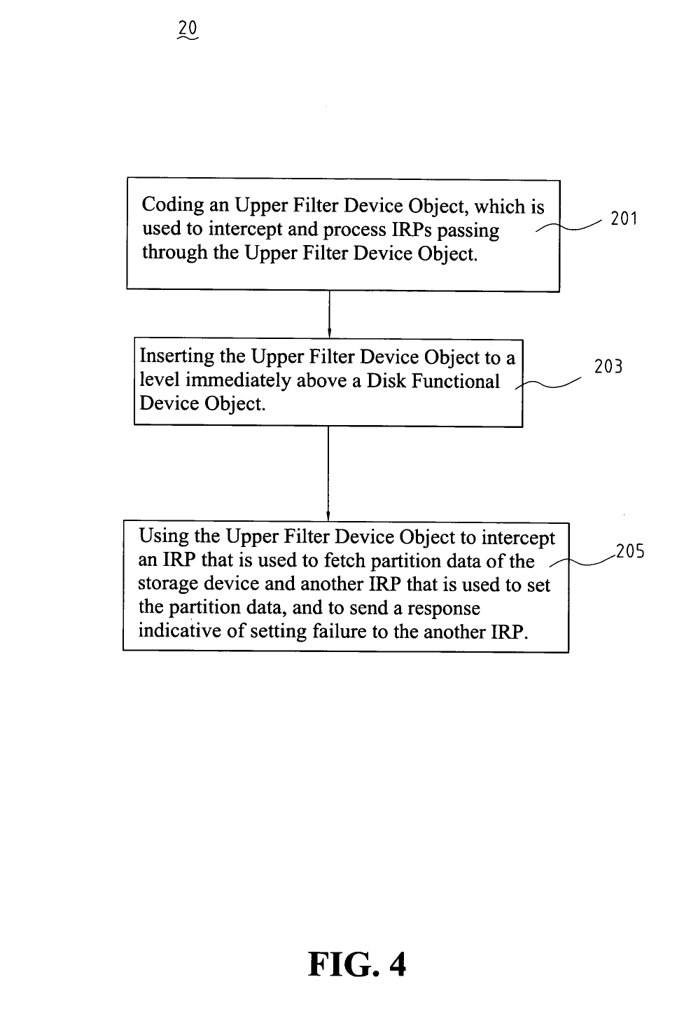

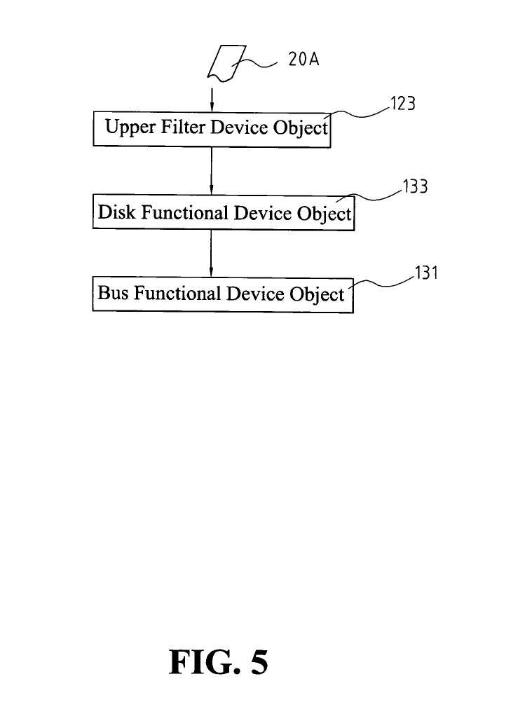

According to the spirit and principal of FIG. 2E, a delete-proof method capable of protecting a storage device for a Windows operating system is further disclosed. FIG. 4 shows a flowchart of the delete-proof method capable of protecting a storage device for Windows operating system according to the invention. FIG. 5 shows a driver configuration of implementing delete-proof method according to the invention. The delete-proof method 20 essentially protects the storage device from a delete partition operation. The delete-proof method 20 includes steps 201, 203 and 205 respectively described as follows. Step 201 codes the Upper Filter Device Object 123, which can intercept and process passing IRPs (I/O Request Packets) 20A, especially intercepting an IRP 20A associated with a partition data of a storage device.

Step 203 inserts the Upper Filter Device Object 123 to the level above Disk Functional Device Object 133, i.e., the Upper Filter Device Object 123 is inserted into the upper level of the Disk Functional Device Object 133. In step 205, the Upper Filter Device Object 123 intercepts the IRP 20A which is used to set the partition data of the storage device and sends a response indicative of setting failure to the IRP 20A.

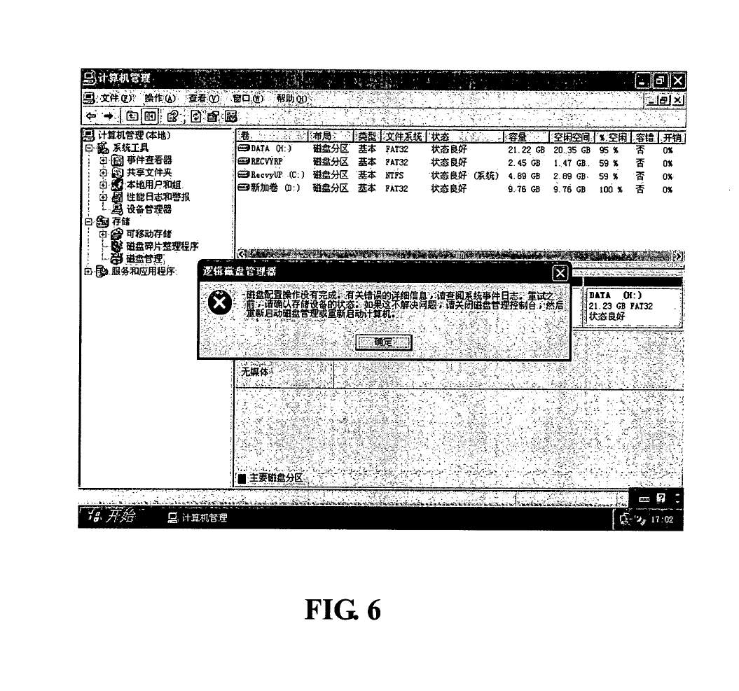

In FIG. 5, the delete-proof method 20 uses a special IRP 20A, IoControlCode, as IRP_MJ_DEVICE_CONTROL of IOCTL_DISK_SET_DRIVE_LAYOUT_EX. The IRP 20A is typically used to set a DPT (Disk Partition Table) of the storage device to accordingly change the partition configuration of the entire storage device. The delete-proof method 20 codes an Upper filter driver of Disk Class Driver to intercept the IRP 20A for avoiding a mistake of deleting a special partition. The Upper filter driver is implemented as the Upper Filter Device Object 123 to check the partition data contained in the IRP 20A. If the partition data directs to a change of a protected partition, the Upper Filter Device Object 123 makes the request from the IRP 20A fail. If the partition data is completely unrelated to the change of the protected partition, the Upper Filter Device Object 123 transfers the IRP 20A to the lower level, and the request from the IRP 20A is completed by the lower driver. FIG. 6 shows a delete rejection frame in which a partition of a storage device is changed into a delete-proof partition according to the invention.

The concrete steps executed by the Upper Filter Device Object 123 essentially include:

1. First of all, the special IRP 20A is intercepted, i.e., the IoControlCode is set as IRP_MJ_DEVICE_CONTROL of IOCTL_DISK_GET_DRIVE_LAYOUT_EX. Accordingly, the Upper Filter Device Object 123 gets the information of protected partitions in the DPT (Disk Partition Table). In this step, the Upper Filter Device Object 123 just obtains the required data from the IRP 20A without any processing.

2. Next, the Upper Filter Device Object 123 intercepts another special IRP 20A, i.e., the IoControlCode is set as IRP_MJ_DEVICE_CONTROL of IOCTL_DISK_SET_DRIVE_LAYOUT_EX. The Upper Filter Device Object 123 checks the another IRP 20A to determine if a protected partition is changed. If no protected partition is changed, the Upper Filter Device Object 123 sends the another IRP 20A to the lower level as usual, and the request from the another IRP 20A is completed by the lower driver.

3. If the another IRP 20A is used to change a protected partition, the Upper Filter Device Object 123 sends a special state such as STATUS_INVALID_PARAMETER, and the another IRP 20A is directly returned, without a further transfer to the lower level.

Further, the Upper Filter Device Object 123 is implemented on the upper level of a storage device to be protected. Furthermore, the Upper Filter Device Object 123 can be further implemented to start in booting.

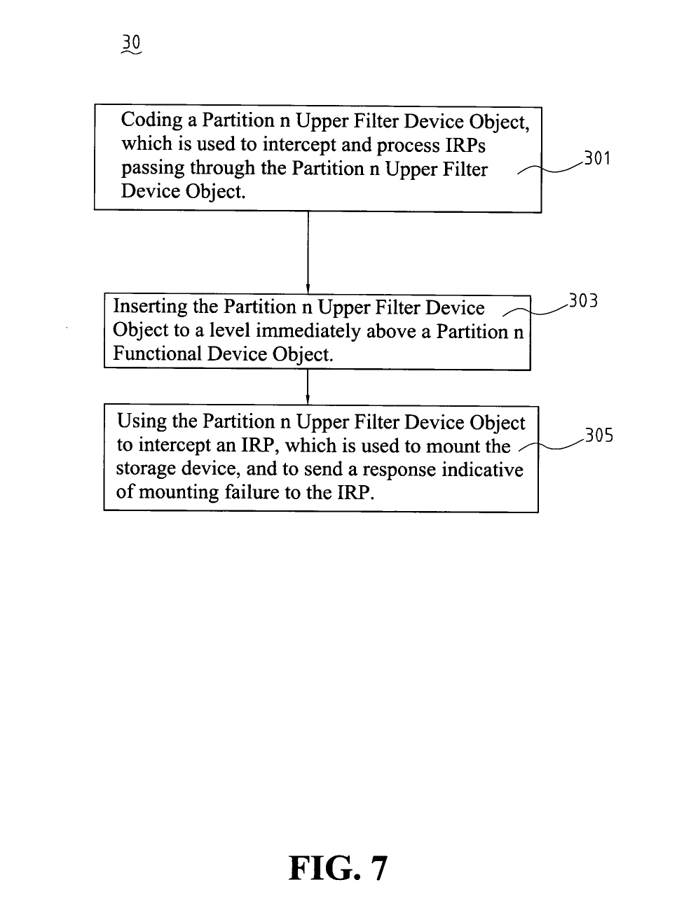

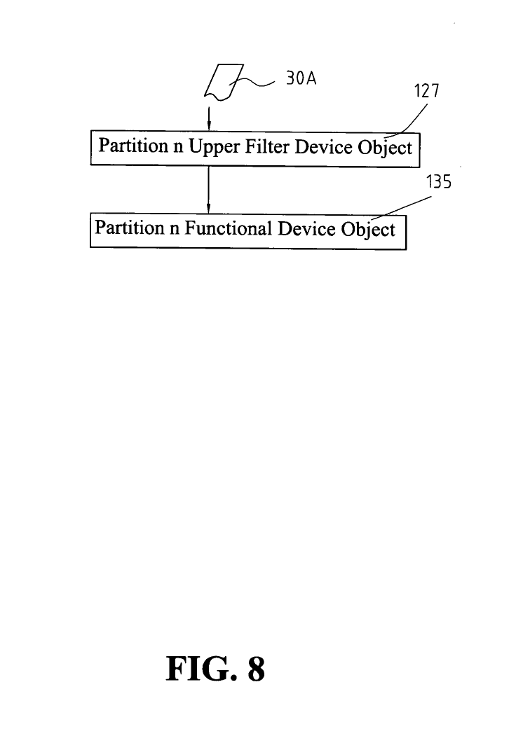

According to the spirit and principle f FIG. 2E, a hidden partition method capable of protecting a storage device for a Windows operating system is further disclosed. FIG. 7 shows a flowchart of a hidden partition method capable of protecting the storage device for a Windows operating system according to the invention. FIG. 8 shows a driver configuration of implementing the hidden partition method according to the invention. The hidden partition 30 can prevent a user to query a partition of a storage device. The hidden partition 30 includes steps 301, 303 and 305 respectively described as follows. Step 301 codes the Partition n Upper Filter Device Object 127, which can intercept and process IRPs (I/O Request Packets) 30A passing through the Partition n Upper Filter Device Object 127.

Step 303 inserts the Partition n Upper Filter Device Object 127 to the level above the Partition n Functional Device Object 135. In step 305, the Partition n Upper Filter Device Object 127 intercepts an IRP 30A, which mounts the storage device and sends a response indicative of mounting failure to the IRP 30A. The cited variables n equals to 1,2,3, . . . , or N, where variable N is a total partition number of the storage device.

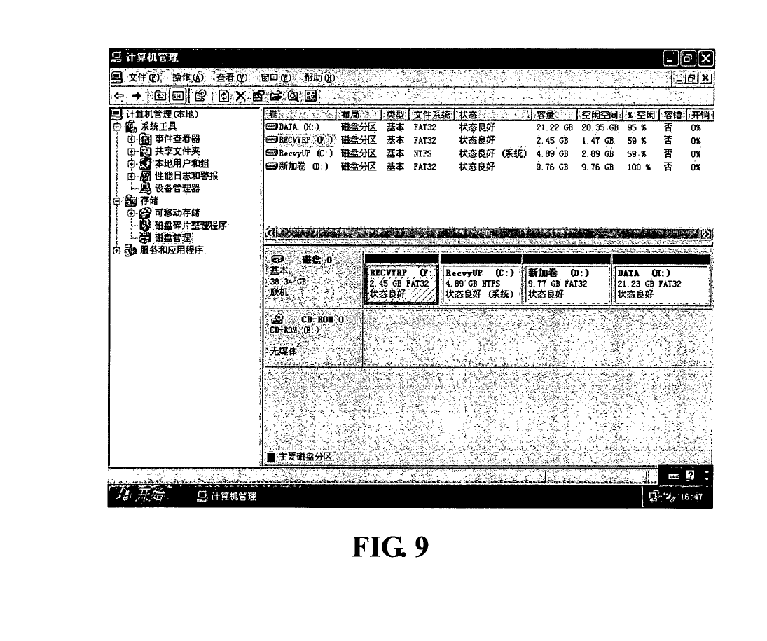

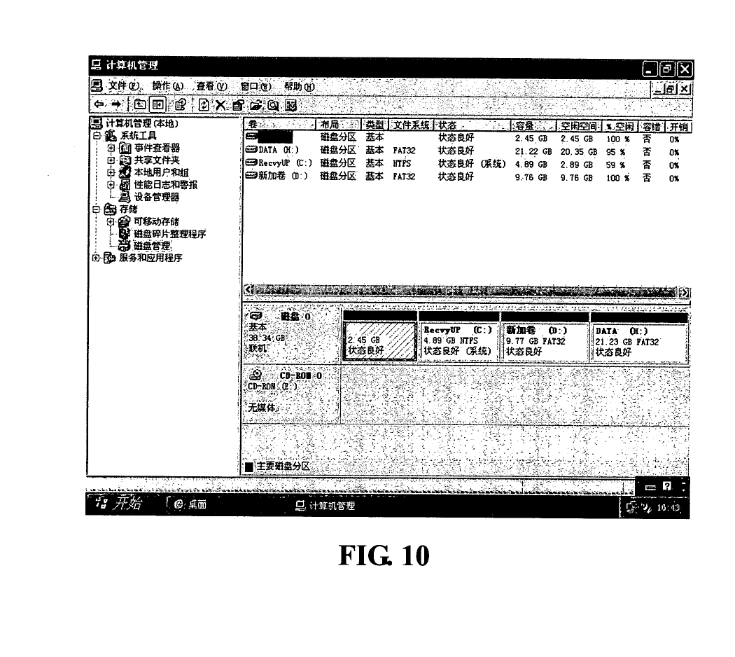

In FIG. 8, the Partition n Upper Filter Device Object 127 intercepts a special IRP 30A, i.e., IoControlCode is set as IRP_MJ_DEVICE_CONTROL of IOCTL_MOUNTDEV_QUERY_DEVICE_NAME. Next, the Partition n Upper Filter Device Object 127 sends a response indicative of mounting failure, such as STATUS_BUFFER_OVERFLOW. Accordingly, the hidden partition method 30 makes the user incapable of querying the data of the partition n because the computer system cannot mount the partition n. FIG. 9 shows a query success frame in which partitions of a storage device is successfully queried since the storage device is not implemented with the hidden partition method of the invention. By contrast, FIG. 10 shows a frame in which a partition of FIG. 9 is changed into a hidden partition by the hidden partition method and thus successfully hidden.

In addition, the Partition n Upper Filter Device Object 127 can be implemented on the upper level of a protected partition of the storage device. Further, the Partition n Upper Filter Device Object 127 is further implemented to start in booting.

Although the present invention has been explained in relation to its preferred embodiment, it is to be understood that many other possible modifications and variations can be made without departing from the spirit and scope of the invention as hereinafter claimed.

What is claimed is:

1. A write-proof method capable of protecting a storage device for a Windows operating system, comprising the steps:
(A) coding a Lower Filter Device Object for the storage device, which is used to intercept and process I/O Request Packets (IRPs) passing through the Lower Filter Device Object;
(B) inserting the Lower Filter Device Object to a level immediately below a Disk Functional Device Object; and
(C) using the Lower Filter Device Object to intercept an IRP, which contains a query about a writable property of the storage device, and to send a response indicative of a write-proof property of the storage device to the IRP.

2. The methods as claimed in claim 1, wherein the storage device is a hard disk or a fixed storage device.

3. The method as claimed in claim 1, wherein the Lower Filter Device Object is implemented to start in booting.

4. A write-proof method capable of protecting a storage device for a Windows operating system, comprising the steps:
(A) coding an Upper Filter Device Object for the storage device, which is used to intercept and process I/O Request Packets (IRPs) passing through the Upper Filter Device Object;
(B) inserting the Upper Filter Device Object to a level immediately above a Disk Functional Device Object; and
(C) using the Upper Filter Device Object to intercept an IRP, which contains a query about a writable property of the storage device, and to send a response indicative of a write-proof property of the storage device to the IRP.

5. The methods as claimed in claim 4, wherein the storage device is a hard disk or a fixed storage device.

6. The method as claimed in claim 4, wherein the Upper Filter Device Object is implemented to start in booting.

7. A write-proof method capable of protecting a storage device for a Windows operating system, comprising the steps:
(A) coding a Partition n Lower Filter Device Object, which is used to intercept and process I/O Request Packets (IRPs) passing through the Partition n Lower Filter Device Object, where n=1,2,3, . . . , or N, and variable N indicates a total partition number of the storage device;
(B) inserting the Partition n Lower Filter Device Object to a level immediately below a Partition n Functional Device Object;
(C) using the Partition n Lower Filter Device Object to intercept an IRP, which contains a query about a writable property of the storage device, and to send a response indicative of a write-proof property of the storage device to the IRP.

8. The methods as claimed in claim 7, wherein the storage device is a hard disk or a fixed storage device.

9. The method as claimed in claim 7, wherein the Partition n Lower Filter Device Object is implemented to start in booting.

10. A write-proof method capable of protecting a storage device for a Windows operating system, comprising the steps:
(A) coding a Partition n Upper Filter Device Object, which is used to intercept and process I/O Request Packets (IRPs) passing through the Partition n Upper Filter Device Object, where n=1,2,3 . . . , or N, and variable N indicates a total partition number of the storage device;
(B) inserting the Partition n Upper Filter Device Object to a level immediately above a Partition n Functional Device Object; and
(C) using the Partition n Upper Filter Device Object to intercept an IRP, which contains a query about a writable property of the storage device, and to send a response indicative of a write-proof property of the storage device to the IRP.

11. The methods as claimed in claim 10, wherein the storage device is a hard disk or a fixed storage device.

12. The method as claimed in claim 10, wherein the Partition n Upper Filter Device Object is implemented to start in booting.

13. A delete-proof method capable of protecting a storage device for a Windows operating system, comprising the steps:
(A) coding an Upper Filter Device Object, which is used to intercept and process I/O Request Packets (IRPs) passing through the Upper Filter Device Object;
(B) inserting the Upper Filter Device Object to a level immediately above a Disk Functional Device Object; and
(C) using the Upper Filter Device Object to intercept an IRP that is used to fetch partition data of the storage device and another IRP that is used to set the partition data, and to send a response indicative of setting failure to the another IRP.

14. The methods as claimed in claim 13, wherein the storage device is a hard disk or a fixed storage device.

15. The method as claimed in claim 13, wherein the Upper Filter Device Object is implemented to start in booting.

16. A hidden partition method capable of protecting a storage device for a Windows operating system, comprising the steps:
(A) coding a Partition n Upper Filter Device Object, which is used to intercept and process I/O Request Packets passing through the Partition n Upper Filter Device Object, where n=1,2,3 . . . , or N, and variable N indicates a total partition number of the storage device;
(B) inserting the Partition n Upper Filter Device Object to a level immediately above a Partition Functional Device Object; and
(C) using the Partition n Upper Filter Device Object to intercept an IRP, which is used to mount the storage device, and to send a response indicative of mounting failure to the IRP.

17. The methods as claimed in any of claims 16, wherein the storage device is a hard disk or a fixed storage device.

18. The method as claimed in claim 16, wherein the Partition n Upper Filter Device Object is implemented to start in booting.
